(19) United States
(12) Patent Application Publication
(10) Pub. No.: US 2012/0063270 A1
(43) Pub. Date: Mar. 15, 2012

(54) Methods and Apparatus for Event Detection and Localization Using a Plurality of Smartphones

(75) Inventors: Robert Charles Angell, West Greenwich, RI (US); Joshua C. Hubbell, West Kingston, RI (US); Eleanor S. Holmes, Falls Church, VA (US); Albert P. Gaines, Coventry, RI (US)

(73) Assignees: Pawcatuck, Connecticut; Rite-Solutions, Inc.

(21) Appl. No.: 13/229,017

(22) Filed: Sep. 9, 2011

Related U.S. Application Data
(60) Provisional application No. 61/381,587, filed on Sep. 10, 2010.
(60) Provisional application No. 61/469,869, filed on Mar. 31, 2011.

(51) Int. Cl. G01S 3/80

(52) U.S. Cl. 367/127

(57) ABSTRACT

An event detection and localization system is provided that employs a plurality of smartphones. The detected events may comprise a gunshot, a biological threat, a chemical threat and/or a radiological threat. Each smartphone comprises a memory for storing an event detection process; and at least one hardware device to implement the event detection process. The hardware device is operative to detect an event based on a signal obtained using a sensor in the vicinity of the smartphone; obtain a time of arrival of the signal; obtain a location of the smartphone at the time of arrival; send a notification of the arrival time and arrival location to one or more of another smartphone and a server; and receive an indication of an origination of the event.

### CROSS REFERENCE TO RELATED APPLICATIONS

This application claims priority to U.S. Provisional Application No. 61/381,587, filed Sep. 10, 2010 and U.S. Provisional Application No. 61/469,869, filed Mar. 31, 2011.

### FIELD OF THE INVENTION

The present invention relates generally to event detection and localization systems, and more particularly, to methods and apparatus for event detection and localization that use smartphones as sensors.

### BACKGROUND OF THE INVENTION

Event detection systems are employed to detect the occurrence of one or more predefined events, such as the detection of a gunshot. Gunshot detection and localization systems (also referred to as gunfire locators) perform gunshot detection (hearing and reporting the occurrence of a gunshot) or gunshot detection and localization (detecting the occurrence of a gunshot and indicating its location and/or direction). Event detection and localization systems are often employed in both military combat and civilian law enforcement environments. Gunshot detection and localization systems, for example, typically detect the location of a gunshot using an array of sensors, such as acoustic or optical sensors. Acoustic sensors, for example, listen for the sound that results from (i) the explosive charge that propels the bullet from the gun; and/or (ii) the bullet moving through the air.

A number of techniques have been proposed or suggested for gunshot detection and localization. For example, U.S. Pat. No. 7,750,814 to Fisher et al. discloses a portable system for detecting and locating the source of gunfire, using man-wearable acoustic sensors. With the continual evolution of technology, such man portable systems are being deployed as non-networked sensor devices for detection and monitoring of threats, such as chemical and radiological elements or events such as gunshots or explosions. While these units provide a useful and more mobile function, they require operator reporting of details and manual integration of the results to provide a true situational awareness of events or environment.

A need therefore remains for improved event detection and localization systems that use a plurality of smartphones as the sensors.

### SUMMARY OF THE INVENTION

Generally, methods and apparatus are provided for event detection and localization using a plurality of smartphones. For example, the detected events may comprise one or more of a gunshot, a biological threat, a chemical threat and a radiological threat. According to one aspect of the invention, an event detection system is provided that comprises a plurality of distributed smartphones. Each smartphone comprises a memory for storing an event detection process; and at least one hardware device to implement the event detection process. The hardware device is operative to detect an event based on a signal obtained using a sensor in the vicinity of the smartphone; obtain a time of arrival of the signal; obtain a location of the smartphone at the time of arrival; send a notification of the arrival time and arrival location to one or more of another smartphone and a server; and receive an indication of an origination of the event. The indicated origination can optionally be presented to the user: For example, a user can optionally be alerted that an event is detected and the user can validate the detected event. The time of arrival can be obtained, for example, by starting a timer process that determines an absolute arrival time in a reference time frame. The location of the smartphone at the time of arrival can be obtained, for example, by enabling a location awareness capability of the smartphone.

The smartphone can optionally interact with one or more servers to employ one or more server-based functions. In addition, smartphone can optionally leverage one or more external sensors, such as biological, chemical and/or radiological sensors.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment where a plurality of smartphones interact with a server and optionally leverage one or more server-based functions to identify a gunshot or another event;

FIG. 2 illustrates an alternative network environment where a plurality of smartphones interact with one another to identify a gunshot or another event;

FIG. 3 is a flow chart describing an exemplary implementation of a smartphone gunshot detection and localization process incorporating aspects of the present invention; and

FIG. 4 illustrates an exemplary user-interface that receives and visualizes gunfire alerts.

### DETAILED DESCRIPTION

The present invention recognizes that the proliferation of position aware handheld processing devices, also referred to herein as smartphones, allows an event detection and localization application to be downloaded into such position aware handheld processing devices. As used herein, a smartphone is a device that combines a cellular telephone with a hand-held computer, typically offering, e.g., Internet access and, data storage. In this manner, the position aware handheld processing devices can act as the sensors and perform gunshot detection and localization functions using the existing features of the smartphones. By using the existing networking, audio detection, and position aware capabilities of the smartphone, and by their inherent distribution across a wide area, the localization can be improved and shared more easily with others quickly.

A preferred embodiment of the invention uses Commercial Off-The-Shelf (COTS) smartphone technology. The present invention recognizes that smartphones can be used to enhance existing types of portable sensors by combining them into sophisticated real-time arrays that aggregate the data from other smartphones

The present invention provides a flexible integration of existing technologies in a robust sensor array network. Smartphones are employed to provide the basic infrastructure to enable low cost, rapidly deployable, highly flexible, and easily mobile systems for detection, localization, and tracking of events, including contaminant plumes, or other things of interest. In one exemplary embodiment, the present invention provides gunshot/explosion detection/localization capabilities using existing capabilities of smartphones (audio, geospatial, WAN communications) with an appropriate client application and optionally server support. The present invention thus provides cost effective and flexible deployment as smartphone deployment reaches greater penetration for first responders and other government personnel.

Currently available smartphones typically incorporate a microphone for communications. If this microphone is maintained in a listening state, it can look for appropriate wave forms indicating a gunshot or another event. In addition, existing mobile devices typically include waveform analysis capabilities to perform speech recognition and other functions that can be tailored to gunshot detection. Existing mobile devices also include communication capabilities (e.g., cellular, Bluetooth and/or Wi-Fi) allowing communication with other devices and/or a centralized server. Existing mobile devices also include a display that allows the user/holder to interact with the device and enables the display of information about detected gunshots (such as range and bearing). Finally, existing mobile devices typically also include a Global Positioning System (GPS) that allows a mobile device to determine a location for the particular mobile device, which can be uses for localization.

In addition, the existing functions of smartphones can be extended using server-based functions, as well as external local sensors. Such server-based functions provide additional functionality for sensors that are not currently available on smartphones. For example, speech recognition functionality may be server (or network) based. Sensors such as portable electronic dosimeters or chemical detectors when coupled to a geospatially aware smartphone and the appropriate server components (or even without server components by providing client to client interactions) can result in a rapidly deployable, flexible, mobile, and yet relatively inexpensive detection, tracking, and mapping system.

Adaptation of existing external COTS sensors using Bluetooth technology can mean that no physical modifications are required to the standard and available smartphones. Possible external COTS or custom sensors include high sensitivity audio or pressure wave sensors (for gunshot and explosion detection), biological, chemical or radiological detectors. A local external biological, chemical or radiological sensor, for example, can detect an event or hazard, communicate with the smartphone and then the smartphone would incorporate the time and geospatial data and communicate it to either the other smartphones or the server(s). A quality microphone could also be an external local sensor communicating with the smartphone. Protocols can be employed to allow near plug and play capability so that additional sensors can be integrated and rapidly deployed as they are developed

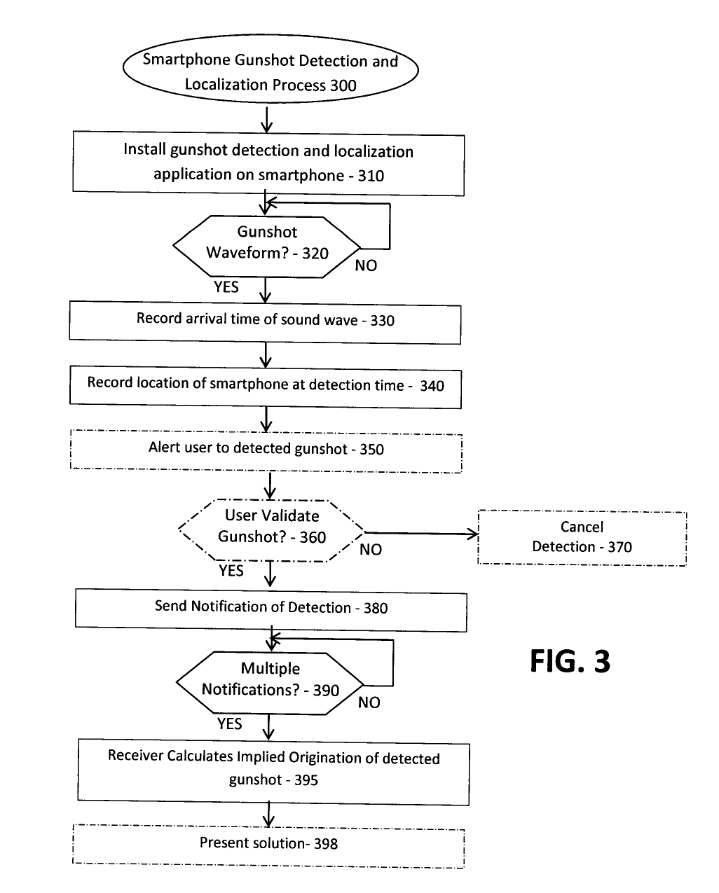

The distributed smartphones form a network of nodes for a gunshot detection and localization system. When the installed gunshot detection and localization application runs in the background, the application can listen for and react to gunshot waveforms, as discussed further below in conjunction with FIG. 3.

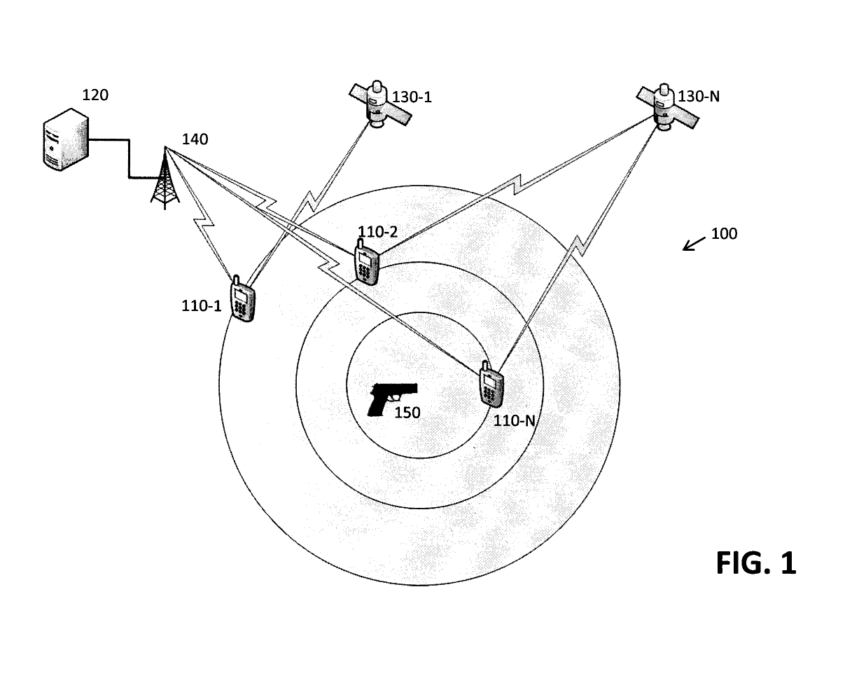

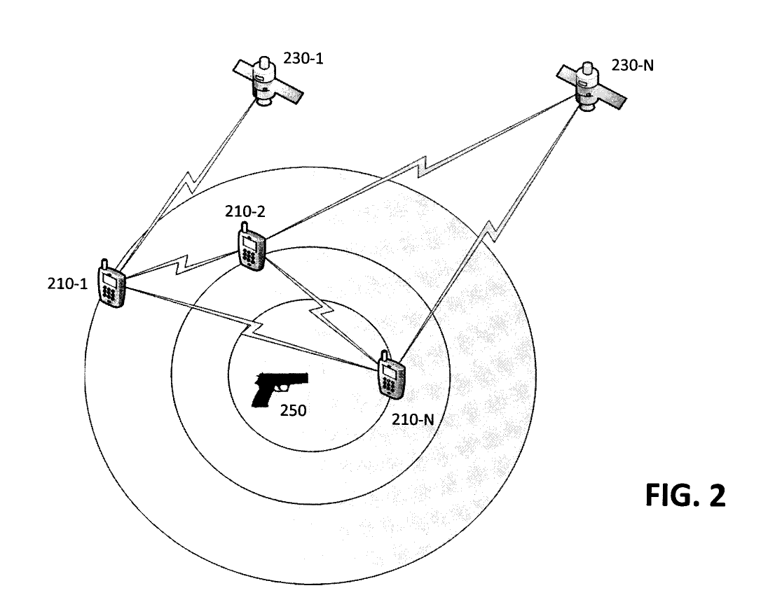

Two exemplary implementations are presented in FIGS. 1 and 2:

FIG. 1 illustrates a network environment 100 where a plurality of smartphones 110-1 through 110-N interact with a server 120 and optionally leverage one or more server-based functions to identify a gunshot from a gun 150 (or another event). In addition, the smartphones 110 optionally communicate in a known manner with one or more global positioning system (GPS) satellites 130-1 through 130-N. The smartphones 110 also communicate in a known manner with one or more cellular base stations 140. The centralized server-based approach of FIG. 1 allows each smartphone 110 to pass information to and receive from the server 120. FIG. 1 has particular application, for example, in a law enforcement environment where adequate wide area networking (via cellular) might be available.

Arrayed sensor networks have been deployed for many purposes and for many years. Sound Surveillance Systems (SOSUSs) were comprised of arrays of hydrophones deployed in the 1960s to track submarines. The smartphones 110 of FIG. 1 provide significant elements of an arrayed sensor network including geospatial awareness, communications (WAN and LAN), synchronized timing, local processing, and graphical operator interface. The ad-hoc arrayed sensor network of FIG. 1 provides enhanced detection, tracking, monitoring, and reporting of events and elements (chemical, radiological, etc.) at a fraction of the cost of existing methods with easier and faster deployment. In some cases (gunshot detection), only the addition of specific smartphone applications and possibly server processing provide the complete sensor array.

FIG. 2 illustrates an alternative network environment 200 where a plurality of smartphones 210-1 through 210-N interact with one another (for example, using Bluetooth or cellular communications) and optionally with one or more GPS satellites 230-1 through 230-N, to identify a gunshot from a gun 250 (or another event).

The second figure is for the isolated approach where the only available elements are the smartphones themselves. In this implementation, the phones all pass their available information to all other available smartphones and the smartphones serve as the environment to perform appropriate calculations and then exchange their solutions.

In practice, the preferred implementation would probably be to allow both modes to operate simultaneously and use either or both when the networking exists but operate in the more independent mode when wider area connectivity is not available.

FIG. 3 is a flow chart describing an exemplary implementation of a smartphone gunshot detection and localization process 300 incorporating aspects of the present invention. While the exemplary process 300 is illustrated using the detection of a gunshot as the detected event, the exemplary process 300 could be modified or extended to detect additional or alternative events, such as biological, radiological and/or chemical threats, as would be apparent to a person of ordinary skill in the art.

As shown in FIG. 3, a gunshot detection and localization application is initially installed on a smartphone during step 310. Thereafter, during step 320, the installed gunshot detection and localization application listens for gunshot waveforms. The monitoring performed during step 320 can optionally include classification techniques to ensure that any detected gunfire is reliably distinguished from similar noises, such as firework explosions and cars backfiring.

Upon detection of a gunshot waveform during step 320, the smartphone gunshot detection and localization process 300 records the time of arrival of the sound wave during step 330 and records the location of the smartphone at the time of detection during step 340.

In recording the time of the detection during step 330, the primary requirement is to begin a timer process that can then use a highly accurate and synchronized time from either a cell tower 140 or GPS time to determine the absolute arrival time in a reference frame that is the same for all the smartphones 110 in the network 100.

If the smartphone GPS or location awareness capability (location awareness may also utilize cell tower information to determine a less accurate location) is not enabled when the gunshot is detected during step 320, the GPS or location awareness capability is enabled during step 340 to determine the location of the smartphone. It is noted that the GPS or location awareness capability is typically disabled to conserve battery on the smartphone. While enabling the location detection during step 340 after the gunshot is detected during step 320 allows for the phone to be moved before a location can be determined, this is unlikely to introduce a great deal of error since the smartphone ## is unlikely to be moving very fast.

The smartphone gunshot detection and localization process 300 optionally alerts the user that a gunshot is detected during step 350. The user can then optionally validate the detection during step 360. If the user does not validate the detection during step 360, the detection can be cancelled during step 370, if it can be confirmed that the detection is a false alarm.

If the user validates the detection during step 360, a notification (e.g., with the arrival time and arrival location) can be sent during step 380 to other smartphone nodes in the local environment and/or to a central server, if present. In this manner, a number of notified smartphones can calculate the implied origination of the gunshot. For example, the notification can be directly between smartphones, for example, via Bluetooth, cellular, Wi-Fi or other wireless technology). In addition, the notification can be a multicast (one-to-many); a unicast (one-to-one) or a mesh approach (one smartphone notifying other smartphones, which, in turn, notify other smartphones). Various protocols can be used, such as UDP or TCP, depending on the network environment and whether there is a desire to confirm receipt to the various receivers, as would be apparent to a person of ordinary skill in the art. Alternatively, the notification of the arrival time and arrival location can be provided from each smartphone node to a centralized server.

A test is performed during step 390, to determine if multiple notifications of the arrival time and arrival location of a potential gunshot are available from multiple smartphones. If it is determined during step 390 that multiple notifications are not available, then program control waits in step 390 until multiple notifications are available. If, however, it is determined during step 390 that multiple notifications are available, then the receiver calculates an implied origination of the detected gunshot during step 395. As more data is available, the solution can be refined or improved, as would be apparent to a person of ordinary skill in the art.

It is again noted that an implementation may be server-based (for example, as shown in FIG. 1, where a wide area network exists) or smartphone-based (for example, as shown in FIG. 2, in an environment where there is minimal infrastructure, such as a remote military environment for instance).

The solution is then optionally presented to the users during step 398 on their respective smartphone display. If the smartphone has a compass, it can even provide a pointing approach to show the holder where the solution expects the origination point to be as well as providing a range.

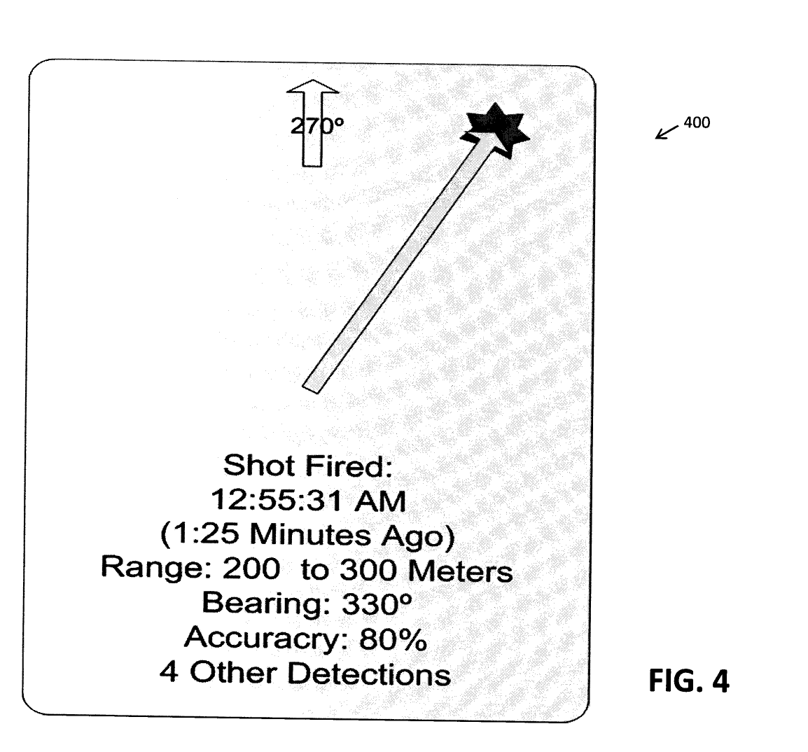

FIG. 4 illustrates an exemplary user-interface 400 that receives and visualizes gunfire alerts. Systems used in urban settings integrate a GPS so the visualization optionally presents information on a map and/or with an address location of each incident As previously indicated, the smartphone gunshot detection and localization systems of the present invention can be considerably less expensive and easier to deploy than dedicated acoustic sensors. In addition, the disclosed smartphone gunshot detection and localization systems can have a large number of inexpensive sensors, it may be possible to make up for the lower quality of the sensor by having more of them. In addition, the wide distribution and proliferation of smartphones reduces the exposure to attacks against fixed-location dedicated sensors.

As previously indicated, the arrangements of smartphone gunshot detection and localization systems, as described herein, provide a number of advantages relative to conventional arrangements. As indicated above, the disclosed techniques for implementing a gunshot detection and localization systems based on a plurality of smartphones allow a deployment that is considerably less expensive and easier than dedicated acoustic sensors.

Again, it should be emphasized that the above-described embodiments of the invention are intended to be illustrative only. In general, the exemplary smartphone gunshot detection and localization systems can be modified, as would be apparent to a person of ordinary skill in the art, to incorporate a plurality of smartphones. In addition, the disclosed techniques for smartphone gunshot detection and localization systems can be applied to the firing of other weaponry as well.

In further variations, the disclosed smartphone gunshot detection and localization systems can also provide a range of other functions following localization. These include providing a countdown (range and bearing) to the user as they approach the indicated solution spot, image capture for later analysis, indication of other units (law enforcement or soldiers) in the area, and the occurrence of multiple shots or type of shot (based on the waveform {gun type})

In addition, the disclosed smartphone gunshot detection and localization systems can employ external sensor elements (for example, for chemical or radiologic elements).

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, application specific integrated circuit, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

It is to be understood that the embodiments and variations shown and described herein are merely illustrative of the principles of this invention and that various modifications may be implemented by those skilled in the art without departing from the scope and spirit of the invention.

We claim:

1. An event detection system, comprising:
a plurality of distributed smartphones, each comprising:
a memory for storing an event detection process; and
at least one hardware device to implement the event detection process, said at least one hardware device operative to:
detect an event based on a signal obtained using a sensor in the vicinity of said smartphone;
obtain a time of arrival of the signal;
obtain a location of the smartphone at the time of arrival;
send a notification of the arrival time and arrival location to one or more of another smartphone and a server; and
receive an indication of an origination of the event.

2. The event detection system of claim 1, wherein said at least one hardware device is further operative to present said origination to the user:

3. The event detection system of claim 1, wherein said time of arrival is obtained by starting a timer process that determines an absolute arrival time in a reference time frame.

4. The event detection system of claim 1, wherein said location of the smartphone at the time of arrival is obtained by enabling a location awareness capability of the smartphone.

5. The event detection system of claim 1, wherein said at least one hardware device is further operative to alert a user that an event is detected and obtain a validation of the detected event from the user.

6. The event detection system of claim 1, wherein said received indication of an origination of the event is received from another smartphone or the server.

7. The event detection system of claim 1, wherein said at least one hardware device is operative to interact with one or more servers to employ one or more server-based functions.

8. The event detection system of claim 1, wherein said at least one hardware device is operative to interact with one or more external sensors.

9. The event detection system of claim 1, wherein said event comprises one or more of a gunshot, a biological threat, a chemical threat and a radiological threat.

10. A method of processing event location information in an event detection system comprised of a plurality of distributed smartphones that execute a smartphone event detection process, the method comprising:
detecting an event based on a signal obtained using a sensor in the vicinity of said smartphone;
obtaining a time of arrival of the signal;
obtaining a location of the smartphone at the time of arrival;
sending a notification of the arrival time and arrival location to one or more of another smartphone and a server;
receiving an indication of an origination of the event.

11. The method of claim 10, further comprising the step of presenting said origination to the user:

12. The method of claim 10, wherein said time of arrival is obtained by starting a timer process that determines an absolute arrival time in a reference time frame.

13. The method of claim 10, wherein said location of the smartphone at the time of arrival is obtained by enabling a location awareness capability of the smartphone.

14. The method of claim 10, further comprising the step of alerting a user that an event is detected and obtain a validation of the detected event from the user.

15. The method of claim 10, wherein said received indication of an origination of the event is received from another smartphone or the server.

16. The method of claim 10, further comprising the step of interacting with one or more servers to employ one or more server-based functions.

17. The method of claim 10, further comprising the step of interacting with one or more external sensors.

18. The method of claim 10, wherein said event comprises one or more of a gunshot, a biological threat, a chemical threat and a radiological threat.

19. A smartphone for use in an event detection system, comprising:
a memory for storing a smartphone event detection process; and
at least one hardware device to implement the smartphone event detection process stored in the memory, said at least one hardware device operative to:
detect an event based on a signal obtained using a sensor in the vicinity of said smartphone;
obtain a time of arrival of the signal;
obtain a location of the smartphone at the time of arrival;
send a notification of the arrival time and arrival location to one or more of another smartphone and a server; and
receive an indication of an origination of the event.

20. The smartphone of claim 19, wherein said event comprises one or more of a gunshot, a biological threat, a chemical threat and a radiological threat.
